(19) United States
(12) Patent Application Publication
(10) Pub. No.: US 2026/0072763 A1
(43) Pub. Date: Mar. 12, 2026

(54) OPERATION MODE SETTING DEVICE, OPERATION MODE SETTING METHOD, OPERATION MODE SETTING PROGRAM AND SYSTEM

(71) Applicant: NTT, Inc., Tokyo (JP)

(72) Inventors: Eriko IWASA, Tokyo (JP); Masashi KANEKO, Tokyo (JP)

(73) Assignee: NTT, Inc., Tokyo (JP)

(21) Appl. No.: 19/108,742

(22) PCT Filed: Sep. 7, 2022
(86) PCT No.: PCT/JP2022/033580

§ 371 Date: Mar. 5, 2025

(51) Int. Cl. G06F 9/50

(52) U.S. Cl. CPC G06F 9/5094; G06F 9/5044; G06F 9/5077

(57) ABSTRACT

The operation mode setting device includes a storage unit, a monitoring unit, and an HW setting control unit. The storage unit stores a plurality of operation modes of the hardware and power characteristic data including power efficiency PE and a performance index value PIV. The monitoring unit acquires metrics data including a current load factor LF of the hardware in operation. The HW setting control unit consults the power characteristic data to select an operation mode in descending order of the power efficiency PE at the current load factor LF of the metrics data. If the performance index value PIV at the current load factor in the selected operation mode satisfies a predetermined performance requirement, the HW setting control unit causes the hardware to operate in the selected operation mode.

### TECHNICAL FIELD

The present invention relates to an operation mode setting device, an operation mode setting method, an operation mode setting program and an operation mode setting system.

### BACKGROUND ART

In recent years, there has been a concern about an increase in power consumption by IT devices, and in a server farm such as a data center, power efficiency has attracted attention in addition to device performance.

Power efficiency shows different trends depending on hardware architecture. In addition, even in the same hardware, the tendency of the power efficiency varies by changing settings such as the number of CPU cores to be activated, maximum/minimum frequency, C-state, dynamic voltage and frequency scaling (DVFS), and FAN setting.

A virtualization infrastructure abstracts and hides hardware constituting servers and/or networks using virtualization techniques and constructs virtual machines or containers which is an execution environment. The virtualization infrastructure is a system that manages a virtual environment prepared as a common infrastructure for a plurality of applications and services and the virtual environment thereof.

In many cases, a de facto standard open source software (OSS) such as OpenStack or Kubernetes is used as an open source virtualization infrastructure in the market. OpenStack is software for constructing a cloud environment and mainly manages and operates physical machines and virtual machines. Kubernetes is software for managing and automating containerized workloads and services.

Virtualization infrastructures optimize resource usage and power consumption of hardware by, for example, dynamic scaling and migration (see, for example, Non-Patent Literature 1). Commercial virtualization infrastructures typically have an auto-scaling function that automatically adjusts the number of virtual machines and containers based on the usage situation of the system.

Further, virtualization infrastructures optimize the frequency and voltage using DVFS techniques (see, for example, Non-Patent Literature 2). The DVFS techniques can reduce power consumption of a server by dynamically changing the clock frequencies of CPUs and the voltages of CPU cores according to a load of the server.

### CITATION LIST

### Non-Patent Literature

Non-Patent Literature 1: Than, Moh Moh, and Thandar Thein. “Energy-Saving Resource Allocation in Cloud Data Centers” 2020 IEEE Conference on Computer Applications (ICCA). IEEE, 2020.

Non-Patent Literature 2: Kuehn, P.J. and Mashaly, M. “DVFS-power management and performance engineering of data center server clusters” 2019 15th Annual Conference on Wireless Ondemand Network Systems and Services (WONS), IEEE, pp. 91-98 (2019).

### SUMMARY OF THE INVENTION

### Problems to Be Solved by the Invention

The power efficiency of a server varies depending on the load applied to the server, and particularly at the time of low load, the power efficiency tends to decrease due to the base power (power consumed regardless of the load). In this case, it is possible to reduce power consumption to improve power efficiency by changing hardware settings (the number of CPU cores to be activated, maximum/minimum frequency, C-state, DVFS, FAN setting, and the like).

On the other hand, when the load of the server increases, the power efficiency improves compared to when the load is low, but in the setting of reducing power consumption, the performance (throughput, latency, and the like) of the server may deteriorate. In this case, the server may not be able to meet the performance requirements agreed in a service level agreement (SLA).

Virtualization infrastructures in the market generally does not change hardware setting during operation of a server. As described above, in virtualization infrastructures, auto-scaling is typically employed to control the number and arrangement of virtual machines or containers according to the load of the server and optimize the number of pieces of hardware to be operated.

However, virtualization infrastructures in the market fail to take into account of dynamically changing the settings of individual hardware. Due to this, when executing an application for which the CPU load is concentrated, particularly in a situation where the load is low immediately after hardware is added in scaling, there is a high possibility that the hardware operates in a state of low power efficiency. Further, when executing an application for which the memory load is concentrated, as the load of the CPU is in a low state regardless of scaling, there is a high possibility that the hardware is operating in a low power efficiency state.

In view of this, it is demanded to dynamically set an operation mode of hardware (combination of items affecting power consumption of the hardware) during operation of the hardware to improve power efficiency while satisfying performance requirements required of the hardware.

### Solution to Problem

An operation mode setting device according to the present invention is an operation mode setting device to be provided in a system including hardware and a virtualization infrastructure that constructs virtual machines or containers by allocating resources of the hardware, the operation mode setting device including: a storage unit that stores a plurality of operation modes composed of combinations of items which relate to power consumption of the hardware and which can be dynamically set in the hardware, and, for each of the plurality of operation modes, power characteristic data including power efficiency and a performance index value, acquired while varying a load factor of the hardware; a monitoring unit that monitors the hardware in operation to acquire metrics data including the load factor of the hardware; and an operation mode setting unit that consults the power characteristic data to select an operation mode from the plurality of operation modes in descending order of the power efficiency at the load factor in the metrics data and, if the performance index value at the load factor in the selected operation mode satisfies a predetermined performance requirement of the hardware, causes the hardware to operate in the selected operation mode.

### Advantageous Effects of Invention

According to the present invention, it is possible to dynamically set an operation mode of hardware (combination of items affecting power consumption of the hardware) during operation of the hardware and improve power efficiency while satisfying performance requirements required of the hardware.

### BRIEF DESCRIPTION OF THE DRAWINGS

FIG. 1 is a block diagram illustrating a configuration example of a system including an operation mode setting device according to the present embodiment.

FIG. 2 is a diagram illustrating a configuration of the system according to the present embodiment.

FIG. 3 is a diagram illustrating an example of settings of operation modes of hardware.

FIG. 4 is a diagram illustrating an example of data of power consumption of each operation mode.

FIG. 5 is a diagram illustrating an example of data of power efficiency of each operation mode.

FIG. 6 is a diagram illustrating an example of data of a performance index value (latency) of each operation mode.

FIG. 7 is a flowchart illustrating a flow of processing of the operation mode setting device according to the present embodiment.

FIG. 8 is a hardware configuration diagram illustrating an example of a computer that implements functions of the operation mode setting device according to the present embodiment.

FIG. 9 is a block diagram illustrating a configuration example of a system including an operation mode setting device according to a modification 1.

### MODES FOR CARRYING OUT THE INVENTION

Next, an embodiment for carrying out the present invention (hereinafter, referred to as the “present embodiment”) will be described with reference to the drawings.

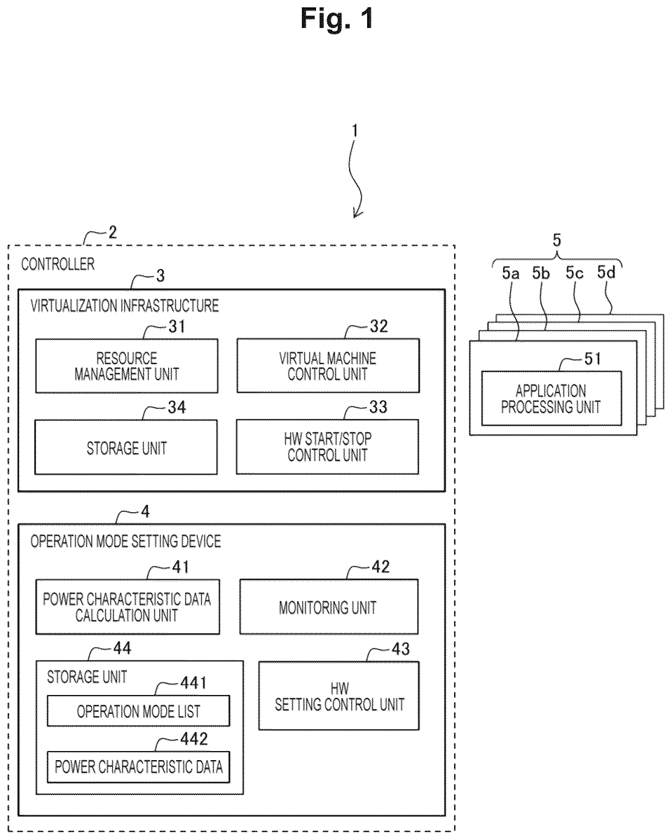

FIG. 1 is a diagram illustrating a configuration example of a system 1 including an operation mode setting device 4 according to the present embodiment.

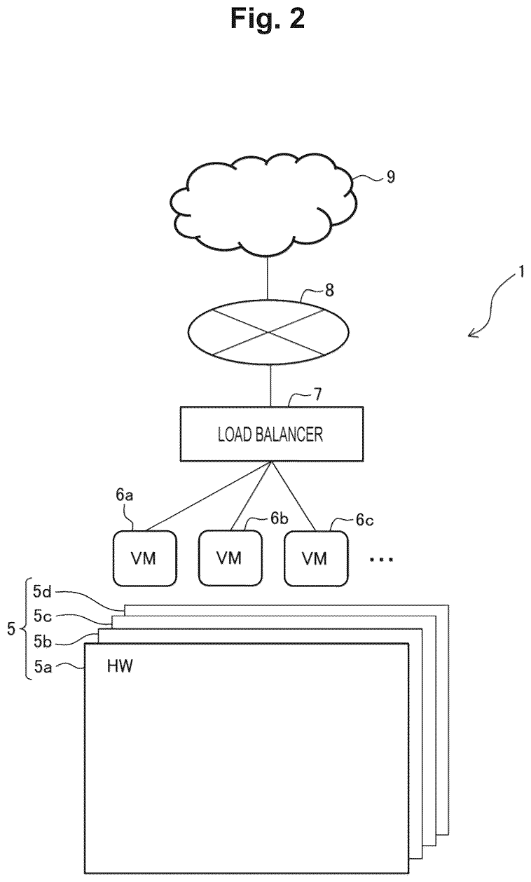

FIG. 2 is a diagram illustrating the configuration of the system 1 according to the present embodiment.

Regarding the present embodiment, a description will be given of an example in which the operation mode setting device 4 is configured together with a virtualization infrastructure 3 in the market as a controller 2 of the system 1.

As illustrated in FIG. 1, the system 1 according to the present embodiment includes a plurality of pieces of hardware 5a, 5b, 5c, 5d . . . constituting servers and/or networks, and a controller 2 that controls the plurality of pieces of hardware 5a, 5b, 5c, 5d . . . . The hardware 5a, 5b, 5c, 5d . . . may include accelerator resources such as a graphics processing unit (GPU) and a field-programmable gate array (FPGA).

The controller 2 includes the virtualization infrastructure 3 and the operation mode setting device 4.

As illustrated in FIG. 2, the virtualization infrastructure 3 abstracts and hides the plurality of pieces of hardware 5a, 5b, 5c, 5d . . . constituting servers and/or networks using virtualization techniques, and manages virtual machines (VMs) 6a, 6b, 6c . . . each operating on any one of the pieces of hardware 5a, 5b, 5c, 5d . . . .

A load balancer 7 is connected to each of the virtual machines 6a, 6b, 6c . . . to distribute traffic from the Internet 9 via a local net 8. The load balancer 7 may also be constructed as a virtual machine.

Each piece of hardware 5a, 5b, 5c, 5d . . . includes an application processing unit 51 (FIG. 1) that executes an application assigned to a virtual machine.

Note that, in the following description, each piece of hardware 5a, 5b, 5c, 5d, . . . will be simply referred to as hardware 5 unless otherwise distinguished. Furthermore, each of the virtual machines 6a, 6b, 6c, . . . will be simply referred to as a virtual machine 6 unless otherwise distinguished.

In addition, although an example in which the virtual machine 6 is used as the execution environment has been described with reference to FIG. 1, a container may be used as the execution environment.

### Virtualization Infrastructure

As illustrated in FIG. 1, the virtualization infrastructure 3 includes a resource management unit 31, a virtual machine control unit 32, a hardware start/stop control unit 33, and a storage unit 34. The hardware start/stop control unit 33 is hereinafter referred to as an “HW start/stop control unit 33”.

The resource management unit 31 manages hardware 5 resources to be allocated to each virtual machine 6.

Furthermore, the resource management unit 31 monitors the load of the resources allocated to each of the virtual machines 6 to periodically collect metrics data such as a load factor and a performance index value.

The virtual machine control unit 32 controls the virtual machine 6 based on the metrics data collected by the resource management unit 31. The virtual machine control unit 32 performs scaling processing, as an example of controlling the virtual machine 6.

Specifically, the scaling processing includes changing of resource allocation to the virtual machine 6, deletion (scaling-in) of the virtual machine 6, addition (scaling-out) of the virtual machine 6, and the like. The virtual machine control unit 32 also changes the number of operations of the hardware 5 as necessary. When changing the number of operations of the hardware 5, the virtual machine control unit 32 inputs an instruction to the HW start/stop control unit 33. The HW start/stop control unit 33 controls starting or stopping of a target hardware 5.

Furthermore, the virtual machine control unit 32 performs the scaling processing in a similar manner also when an instruction of scaling processing is input from the below-described operation mode setting device 4.

The storage unit 34 stores various types of information necessary for processing of the virtualization infrastructure 3.

The storage unit 34 stores, for example, resource information on the hardware 5, information on resource allocation to the virtual machines 6, and the like.

Note that, when a container is used as the execution environment instead of a virtual machine 6, the resource management unit 31 manages the resources of the hardware 5 allocated to each container. In addition, the virtualization infrastructure 3 may be provided with a container control unit instead of the virtual machine control unit 32. The container control unit may, for example, increase or decrease the number of containers as the scaling processing.

### Operation Mode Setting Device

As illustrated in FIG. 1, the operation mode setting device 4 includes a power characteristic data calculation unit 41, a monitoring unit 42, a hardware setting control unit 43 (operation mode setting unit), and a storage unit 44. The “hardware setting control unit 43” is hereinafter referred to as an “HW setting control unit 43”.

As described above, the virtualization infrastructure 3 mainly manages the virtual machines 6a, 6b, 6c . . . each operating on any one of the pieces of hardware 5a, 5b, 5c, 5d . . . . On the other hand, the operation mode setting device 4 is a device that manages the operation mode of each piece of hardware 5 included in the system 1.

The operation mode is composed of a combination of items which relate to power consumption of the hardware 5 and which can be dynamically set in the hardware 5. The item related to the power consumption of the hardware 5 mean, for example, an item that affects the power consumption of the hardware 5.

Examples of the items to be set in an operation mode include the number of CPU cores to be activated, maximum/minimum CPU frequency, maximum/minimum GPU frequency, C-state setting, DVFS setting, FAN setting, and the like.

The operation mode setting device 4 defines a plurality of operation modes of the hardware 5. The plurality of operation modes created in advance is described in an operation mode list 441 and stored in the storage unit 44. The same operation mode list 441 may be used for each piece of hardware 5 constituting the system 1. When pieces of hardware 5 with different specifications are mixed in the system 1, a plurality of operation mode lists 441 respectively corresponding to the specifications of pieces of hardware 5 may be created.

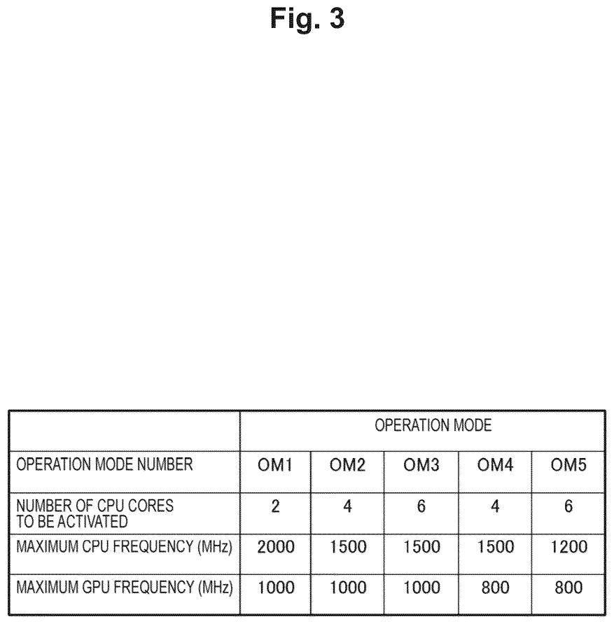

FIG. 3 is a diagram illustrating an example of the settings of operation modes of the hardware 5.

FIG. 3 illustrates five different operation modes OM1 to OM5. FIG. 3 illustrates an example in which the number of CPU cores to be activated, the maximum CPU frequency, and the maximum GPU frequency are used as the setting items of the operation modes OM1 to OM5. For example, in the operation mode OM1, while the number of CPU cores to be activated is set to be as small as 2, the maximum CPU frequency is set to be as high as 2000 MHz and the maximum GPU frequency is set to be as high as 1000 MHz. For example, in the operation mode OM5, while the number of CPU cores to be activated is set as high as 6, the maximum CPU frequency is set to be as low as 1200 MHz and the maximum GPU frequency is set to be as low as 800 MHz. In each of the other operation modes, a numerical value is set for each item.

The power characteristic data calculation unit 41 causes each piece of hardware 5 of the system 1 to operate in each of the plurality of operation modes described in the operation mode list 441 to calculate power characteristic data 442 for each operation mode. For example, the power characteristic data calculation unit 41 may perform trial operations before formal operations of the hardware 5, to calculate the power characteristic data 442. The power characteristic data 442 is used as a determination criterion when the below-described HW setting control unit 43 sets the operation mode of the hardware 5.

The power characteristic data calculation unit 41, for each operation mode, acquires data necessary for calculation of the power characteristic data 442 while varying a load factor LF of the hardware 5. The load factor LF means a usage rate (usage) of the hardware 5 or the number of requests processed (RFS: Request Per Second). The power characteristic data calculation unit 41 measures data of the power consumption, throughput (the number of processed data), and performance index value PIV (e.g., latency) of the hardware 5 while varying the load factor LF of the hardware 5.

The power characteristic data calculation unit 41 further calculates the power efficiency PE of the hardware 5 from the relationship between the measured power consumption and throughput. The power efficiency PE means “a power efficiency transition due to the usage rate when the power efficiency at a usage rate of 100% is defined as 1.0”. When using the power consumption and the throughput, the power efficiency PE is calculated as the number of processes per 1 W.

The power characteristic data calculation unit 41 causes the storage unit 44 to store the performance index value PIV and the calculated power efficiency PE as the power characteristic data 442. The power characteristic data 442 is stored associated with an operation mode described in the operation mode list 441.

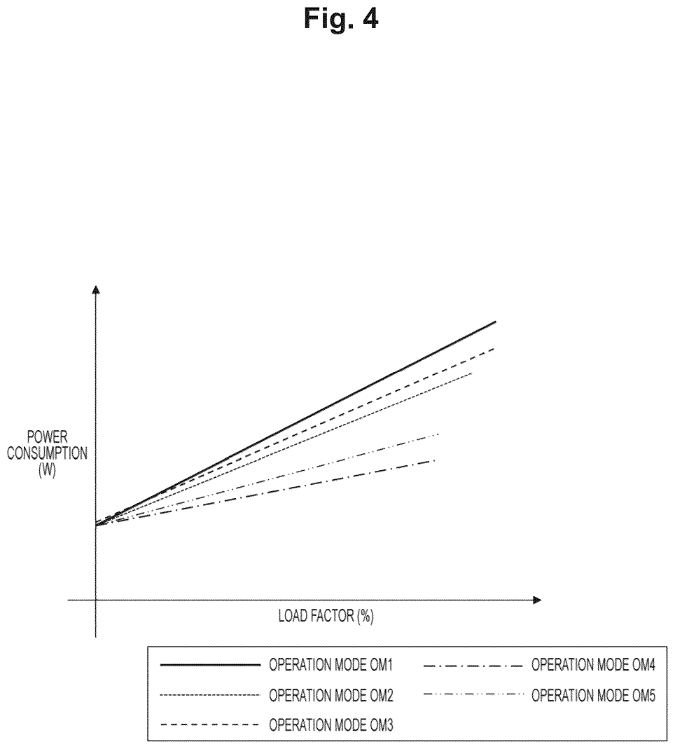

FIG. 4 is a diagram illustrating an example of the data of power consumption for each operation mode.

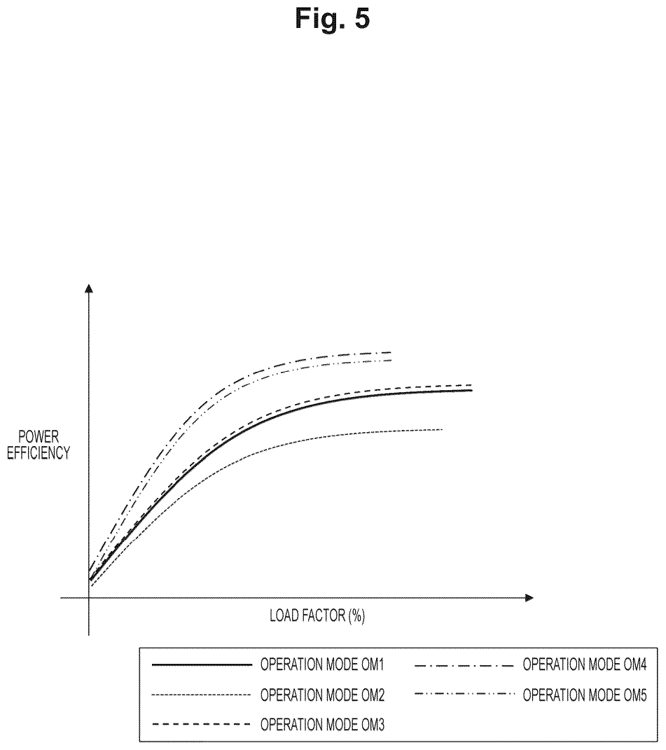

FIG. 5 is a diagram illustrating an example of the data of power efficiency PE of each operation mode.

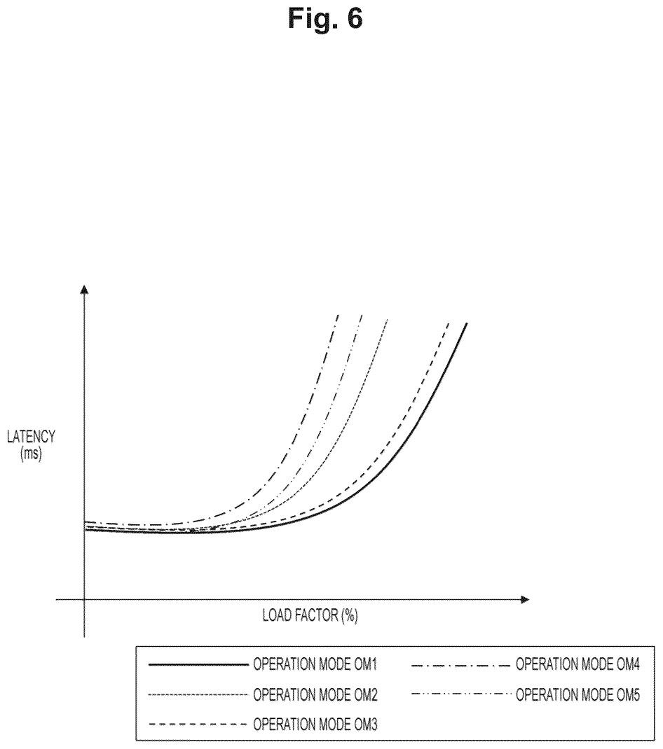

FIG. 6 is a diagram illustrating an example of the data of the performance index value PIV (latency) for each operation mode.

As illustrated in FIGS. 4 to 6, the plurality of operation modes OM1 to OM5, depending on each combination of setting items, indicate different tendencies of the power consumption, the power efficiency PE, and the performance index value PIV.

As illustrated in FIG. 4, the power consumption of the hardware 5 increases in proportion to the increase in the load factor LF, but the rate of increase in power consumption differs depending on the operation mode.

As illustrated in FIG. 5, at a low load factor, the power efficiency PE tends to decrease due to the base power (power consumed regardless of the load), and the power efficiency PE increases as the load factor LF increases. Here, the operation modes OM4 and OM5 exhibit high power efficiency PE at high load factors as compared with the operation modes OM1 to OM3, but also exhibit large performance index value PIVs (latency) at a high load factor as illustrated in FIG. 6.

Returning to FIG. 1, the monitoring unit 42 monitors each piece of hardware 5 during the operation of the hardware 5 to periodically collect the metrics data.

For example, the monitoring unit 42 collects data of load factor LF (usage rate or the number of requests processed) and performance index value PIV such as latency as the metrics data. The metrics data is temporarily stored in the storage unit 44.

In addition, the monitoring unit 42 collects data of load factor LF when the below-described HW setting control unit 43 changes the operation mode of the hardware 5.

The HW setting control unit 43 dynamically selects and sets an operation mode for each piece of hardware 5 in operation from among the plurality of operation modes.

Specifically, the HW setting control unit 43 consults the power characteristic data 442 (FIG. 5) to select an operation mode in which the power efficiency PE at the load factor LF indicated by the metrics data is higher than that in other operation modes from among the plurality of operation modes. When the HW setting control unit 43 consults the power characteristic data 442 (FIG. 6) and finds that the performance index value PIV at the load factor LF in the selected operation mode satisfies the performance requirement of the hardware 5 (hereinafter, referred to as “predetermined performance requirement”) based on a service level agreement (SLA), the HW setting control unit 43 causes the hardware 5 to operate in the selected operation mode.

More specifically, the HW setting control unit 43 reorders the plurality of operation modes of the operation mode list 441 in descending order of the power efficiency PE at the load factor LF indicated by the metrics data. The HW setting control unit 43 selects the operation modes in order starting from the first operation mode in the reordered operation mode list 441, and determines whether the performance index value PIV at the load factor LF in the selected operation mode satisfies the predetermined performance requirement.

That is, the HW setting control unit 43 sets, from among the plurality of operation modes, an operation mode in which the power efficiency PE at the load factor LF of the hardware 5 in operation is high and which satisfies the predetermined performance requirement.

The SLA is an agreement on the level of service, concluded between the provider and the user of the system 1. The hardware 5 constituting the system 1 is required to guarantee the performance index value agreed in the SLA. Thus, the predetermined performance requirement requires that the performance index value be equal to or less than the performance index value (for example, latency) agreed in the SLA.

The HW setting control unit 43, as the determination regarding the predetermined performance requirement, specifically consults the power characteristic data 442 to perform processing for comparing the performance index value PIV of the selected operation mode and a preset performance target value SLO. The performance target value SLO is set using the performance index value agreed in the SLA as a reference. The performance target value SLO (predetermined performance requirement) may be the same as the performance index value agreed in the SLA or may be a value having a margin with respect to the performance index value agreed in the SLA. For example, when the performance index value is of latency, the performance target value SLO may be a value lower than the latency agreed in the SLA.

When the performance index value PIV at the load factor LF in the selected operation mode satisfies the predetermined performance requirement, the HW setting control unit 43 sets the selected operation mode as the operation mode of the hardware 5.

When the performance index value PIV at the load factor LF in the selected operation mode fails to satisfy the predetermined performance requirement, the HW setting control unit 43 selects the operation mode with the next highest power efficiency PE in the operation mode list 441 and determines whether the predetermined performance requirement is satisfied.

Note that, when there is no operation mode that satisfies the predetermined performance requirement in the operation mode list 441, the HW setting control unit 43 outputs a scaling instruction to the virtualization infrastructure 3. As an example, the HW setting control unit 43 outputs an instruction to perform scaling-out by adding a virtual machine 6/container or an instruction to increase the number of pieces of the hardware 5.

The HW setting control unit 43 determines whether the scaling processing is necessary after setting an operation mode that satisfies the predetermined performance requirement.

As described above, the monitoring unit 42 collects the data of load factor LF (the usage rate or the number of requests processed) from the hardware 5 whose operation mode has been changed. When the load factor LF is lower than a preset threshold TH (predetermined threshold), the HW setting control unit 43 outputs a scaling instruction to the virtualization infrastructure 3. As an example, the HW setting control unit 43 outputs an instruction to perform scaling-in by deleting a virtual machine 6/container or an instruction to decrease the number of pieces of hardware 5.

In this manner, when there is an increase or decrease in the load factor that cannot be sufficiently handled by changing the operation mode with respect to the hardware 5, it is possible to handle the increase or decrease by issuing to the virtualization infrastructure 3 an instruction to perform scaling.

As described above, during the operation of the hardware 5, the HW setting control unit 43 dynamically sets the operation mode according to the load factor LF of the hardware 5 measured by the monitoring unit 42.

On the other hand, it is assumed that the load factor LF of the hardware 5 is low at the start of the operation of the hardware 5. In view of this, at the start of the operation of the hardware 5, the HW setting control unit 43 consults the power characteristic data 442 (FIG. 5) to select an operation mode with the highest power efficiency PE at a low load factor (a load factor equal to or less than a predetermined value) from the plurality of operation modes and sets the selected operation mode as the operation mode of the hardware 5. The predetermined value can be set based on the load factor assumed at the start of the operation of the hardware 5.

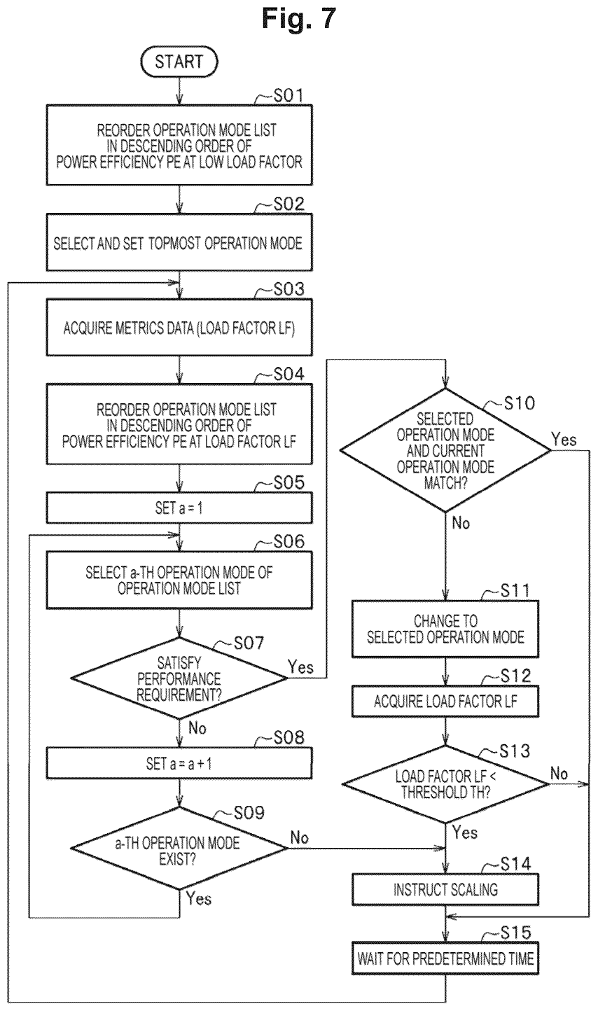

FIG. 7 is a flowchart illustrating a flow of processing of the operation mode setting device 4.

FIG. 7 illustrates processing of the operation mode setting device 4 at the start of the operation of the hardware 5 and during the operation of the hardware 5.

As described above, the power characteristic data calculation unit 41 has calculated the power characteristic data 442 for each of the plurality of operation modes by trial operations in advance and has caused the storage unit 44 to store the power characteristic data 442.

As illustrated in FIG. 7, the HW setting control unit 43 consults the power characteristic data 442 (FIG. 5) in the storage unit 44 to reorder (step S01) the operation modes described in the operation mode list 441 in descending order of the power efficiency PE at a low load factor (load factor equal to or less than a predetermined value).

The HW setting control unit 43 selects the operation mode located first from the top of the operation mode list 441 (operation mode with the highest power efficiency PE) and sets (step S02) the selected operation mode as the operation mode of the hardware 5. The HW setting control unit 43 causes the hardware 5 to operate according to the setting items of the selected operation mode.

During the operation of the hardware 5, the monitoring unit 42 periodically collects (step S03) metrics data (such as the load factor LF) of the hardware 5.

The HW setting control unit 43 acquires the load factor LF of the hardware 5 in operation from the metrics data. The HW setting control unit 43 consults the power characteristic data 442 (FIG. 5) to reorder (step S04) the operation modes described in the operation mode list 441 in descending order of the power efficiency PE at the load factor LF.

The HW setting control unit 43 sets (step S05) a=1 and selects (step S06) the operation mode located a-th from the top of the operation mode list 441.

The hardware 5 setting control unit consults the power characteristic data 442 of the selected operation mode to determine (step S07) whether the performance index value PIV satisfies the predetermined performance requirement.

Specifically, the HW setting control unit 43 performs processing of comparing between the performance index value PIV of the power characteristic data 442 (FIG. 6) at the load factor LF and the performance target value SLO based on the performance index value agreed in the SLA. For example, when the performance index value PIV is of latency, the HW setting control unit 43 determines that the predetermined performance requirement is satisfied when the latency in the metrics data is lower than the performance target value SLO.

If the performance index value PIV of the selected operation mode satisfies the predetermined performance requirement (step S07: Yes), the HW setting control unit 43 proceeds to step S10.

If the performance index value PIV of the selected operation mode fails to satisfy the predetermined performance requirement (step S07: No), the HW setting control unit 43 sets (step S08) a=a+1. Then, the HW setting control unit 43 determines whether an a-th operation mode exists in the operation mode list 441 (step S09). If an a-th operation mode exists in the operation mode list 441 (step S09: Yes), the process returns to step S06, and the HW setting control unit 43 determines whether the predetermined performance requirement is satisfied by the a-th operation mode. In this manner, the HW setting control unit 43 makes determinations regarding the predetermined performance requirement for the operation modes described in the operation mode list 441 in descending order of the power efficiency PE.

If an a-th operation mode does not exist in the operation mode list 441 (step S09: No), that is, if all the operation modes described in the operation mode list 441 fail to satisfy the predetermined performance requirement, the HW setting control unit 43 proceeds to step S14 to instruct the virtual machine control unit 32 of the virtualization infrastructure 3 to perform scaling. In this case, in the hardware 5, as an increase in the load factor that cannot be handled by changing the operation mode is assumed, the HW setting control unit 43 may, for example, issue to the virtualization infrastructure 3 an instruction to perform scaling-out to increase the number of virtual machines 6/containers or an instruction to increase the number of pieces of hardware 5.

In step S10, the HW setting control unit 43 determines whether the selected operation mode matches the operation mode currently set for the hardware 5.

If the operation modes do not match (step S10: No), the HW setting control unit 43 changes (step S11) the operation mode of the hardware 5 to the selected operation mode. The HW setting control unit 43 causes the hardware 5 to operate according to the setting items of the changed operation mode.

In step S10, if the selected operation mode matches the operation mode (step S10: Yes) currently set, the HW setting control unit 43 proceeds to step S15.

In step S12, the monitoring unit 42 acquires data of the load factor LF (usage rate or the number of requests processed) from the hardware 5 whose operation mode has been changed.

The HW setting control unit 43 determines (step S13) whether the load factor LF acquired by the monitoring unit 42 is lower than the threshold TH (predetermined threshold). Then, if load factor LF is equal to or larger than the threshold TH (step S13: No), the process proceeds to step S15.

If the load factor LF acquired by the monitoring unit 42 is lower than the threshold TH (step S13: Yes), the HW setting control unit 43 proceeds to step S14 to instruct the virtualization infrastructure 3 to perform scaling. In this case, as it is assumed that the load factor of the hardware 5 is low even if the operation mode is changed, the HW setting control unit 43 may, for example, issue an instruction to perform scaling-in to reduce the number of virtual machines 6/containers, an instruction to reduce the number of pieces of hardware 5, or the like.

After waiting for a predetermined time in step S15, the operation mode setting device 4 returns to step S03 again. With this, the operation mode setting device 4 cyclically acquires the hardware metrics data and dynamically sets the operation mode during the operation of the hardware 5. That is, the operation mode setting device 4 reexamines the operation mode according to the change in the load factor LF during the operation of the hardware 5, taking into account both the power efficiency PE and the predetermined performance requirement. The operation mode setting device 4 further handles a change in the load factor LF that cannot be handled by changing the operation mode by instructing the virtualization infrastructure 3 to perform scaling.

### Hardware Configuration

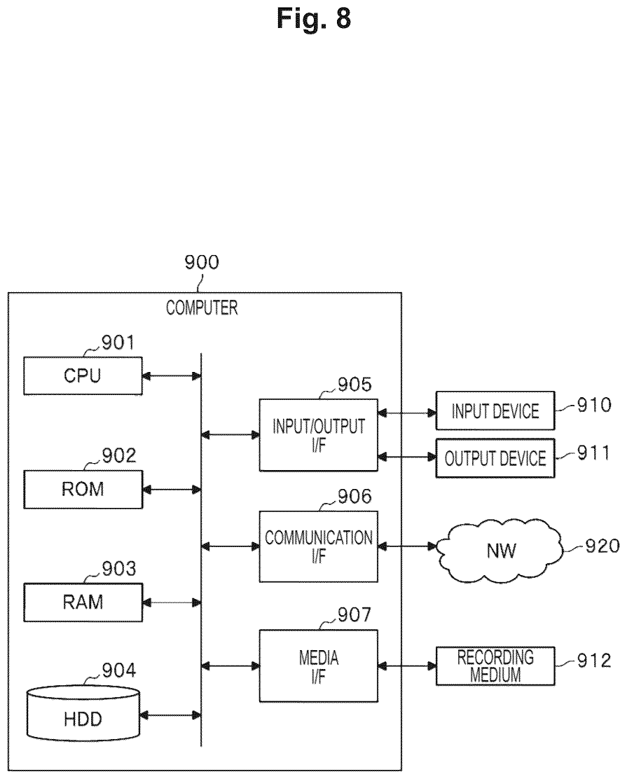

The operation mode setting device 4 according to the present embodiment is implemented by, for example, a computer 900 as illustrated in FIG. 8.

FIG. 8 is a hardware configuration diagram illustrating an example of the computer 900 that implements the functions of the operation mode setting device 4 according to the present embodiment. The computer 900 includes a central processing unit (CPU) 901, a read only memory (ROM) 902, a RAM 903, a hard disk drive (HDD) 904, an input/output interface (I/F) 905, a communication I/F 906, and a media I/F 907.

The CPU 901 operates according to a program (data collection program) stored in the ROM 902 or the HDD 904 to control the operation mode setting device 4 illustrated in FIG. 1. The ROM 902 stores a boot program to be executed by the CPU 901 when the computer 900 is started, a program related to the hardware 5 of the computer 900, and the like.

The CPU 901 controls an input device 910, such as a mouse or a keyboard, and an output device 911, such as a display, via the input/output I/F 905. The CPU 901 acquires data from the input device 910 and outputs generated data to the output device 911 via the input/output I/F 905. Note that a graphics processing unit (GPU) or the like may be used as a processor together with the CPU 901.

The HDD 904 stores a program to be executed by the CPU 901, data to be used by the program, and the like. The communication I/F 906 receives data from another device via a communication network (for example, a network (NW) 920), outputs the data to the CPU 901, and transmits data generated by the CPU 901 to another device via a communication network.

The media I/F 907 reads a program or data stored in a recording medium 912, and outputs the program or data to the CPU 901 via the RAM 903. The CPU 901 loads a program related to target processing from the recording medium 912 into the RAM 903 via the media I/F 907 and executes the loaded program. The recording medium 912 is an optical recording medium such as a digital versatile disc (DVD) or a phase change rewritable disk (PD), a magneto-optical recording medium such as a magneto optical disk (MO), a magnetic recording medium, a conductor memory tape medium, a semiconductor memory, or the like.

For example, when the computer 900 functions as the operation mode setting device 4 according to the present embodiment, the CPU 901 of the computer 900 implements the functions of the operation mode setting device 4 by executing a program loaded on the RAM 903. Further, the HDD 904 stores data in the RAM 903. The CPU 901 reads the program related to the target processing from the recording medium 912 and executes the program. Additionally, the CPU 901 may read the program related to the target processing from another device via the communication network (NW 920).

### Configuration of Embodiments and Effects Thereof

(1) An operation mode setting device 4 is provided in a system 1 including hardware 5 and a virtualization infrastructure 3 that constructs a virtual machine(s) 6 or a container(s) by allocating resources of the hardware 5.

The operation mode setting device 4 includes a storage unit 44, a monitoring unit 42, and a HW setting control unit 43 (operation mode setting unit).

The storage unit 44 stores an operation mode list 441 in which a plurality of operation modes are described and power characteristic data 442. The plurality of operation modes are composed of combinations of items which relate to power consumption of the hardware 5 and which can be dynamically set to the hardware 5, and are stored in the storage unit 44 as the operation mode list 441. The power characteristic data 442 is acquired for each of the plurality of operation modes by a power characteristic data calculation unit 41 while varying a load factor LF of the hardware 5 and includes data of a power efficiency PE and a performance index value PIV.

The monitoring unit 42 monitors the hardware 5 in operation to acquire metrics data including a load factor LF of the hardware 5.

The HW setting control unit 43 consults the power characteristic data 442 to select an operation mode from the plurality of operation modes in descending order of the power efficiency PE at the load factor LF in the metrics data. If the performance index value PIV at the load factor LF in the selected operation mode satisfies a predetermined performance requirement of the hardware 5, the HW setting control unit 43 causes the hardware 5 to operate in the selected operation mode.

According to the present invention, it is possible to dynamically set the operation mode (a combination of items affecting the power consumption of hardware) of the hardware 5 during the operation of the hardware 5 to improve the power efficiency PE while satisfying the performance requirement (predetermined performance requirement) of the hardware 5.

Specifically, the HW setting control unit 43 is able to select an operation mode in which the power efficiency PE is high at the load factor LF of the hardware 5 in operation by consulting the power characteristic data 442. The HW setting control unit 43 further determines whether the performance index value PIV of the selected operation mode satisfies the predetermined performance requirement. With this, the operation mode setting device 4 is able to improve the power efficiency of the hardware 5 while satisfying the predetermined performance requirement.

(2) At the start of the operation of the hardware 5, the HW setting control unit 43 consults the power characteristic data 442 to select an operation mode in which the power efficiency PE at a load factor equal to or less than a predetermined value, i.e., at a low load factor, is high, and causes the hardware 5 to operate in the selected operation mode.

It is generally assumed that, at the start of operation of the hardware 5, the load is low. In view of this, the HW setting control unit 43 selects an operation mode in which the power efficiency PE at a preset low load factor is high, thereby to improve the power efficiency at the start of the operation.

(3) If the load factor LF acquired in the selected operation mode is lower than a threshold TH (predetermined threshold), the HW setting control unit 43 instructs the virtualization infrastructure 3 to execute scaling of the virtual machine(s) 6 or container(s).

With this, in a case where it is not possible to sufficiently handle an increase or decrease of the load factor even by changing the operation mode of the hardware 5, it is possible to improve the power efficiency by increasing or decreasing the number of virtual machines 6/containers by scaling or by increasing or decreasing the number of pieces of hardware 5. In this manner, the system 1 of the present embodiment is able to improve the power efficiency further by combining dynamical setting of the operation mode of the hardware 5 and scaling.

(4) The operation mode setting device 4 includes the power characteristic data calculation unit 41, which, for each of the plurality of operation modes, calculates the power characteristic data 442 including the power efficiency and the performance index value PIV of the hardware 5 while varying the load factor LF of the hardware 5.

With this, it is possible to experimentally operate the hardware 5 before formal operation to obtain highly accurate power characteristic data.

The above-described effects also apply to an operation mode setting method performed by the operation mode setting device 4 and to an operation mode setting program for causing the computer 900 to function as the operation mode setting device 4.

Furthermore, the effects described above can also be applied to the system 1 including the operation mode setting device 4. Regarding the present embodiment, an example has been described in which the operation mode setting device 4 is provided together with the virtualization infrastructure 3 as a controller 2 of the hardware 5. The operation mode setting device 4, in the controller 2, centrally manages the operation modes of the plurality of pieces of the hardware 5. This aspect is particularly effective in a virtualization environment including the same type of the hardware 5.

When scaling is performed in the virtualization infrastructure 3, it is necessary to make determinations regarding a cluster consisting of a plurality of pieces of the hardware 5. The operation mode setting device 4 collects and centrally manages the information on the plurality of pieces of the hardware 5, whereby the determinations by the virtualization infrastructure 3 side are facilitated, and the number of transactions between the virtualization infrastructure 3 and each piece of hardware 5 can be reduced.

### Modification 1

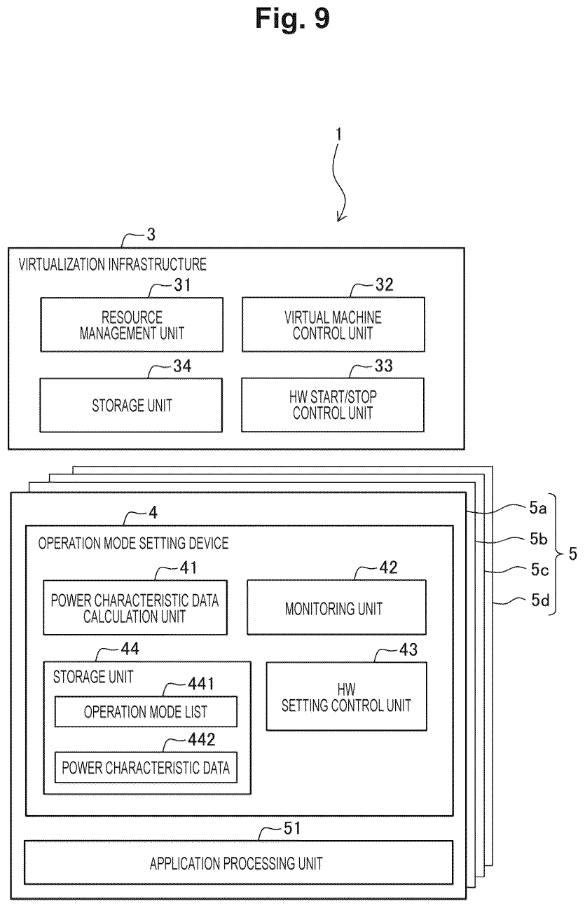

FIG. 9 is a diagram illustrating a configuration example of the operation mode setting device 4 according to Modification 1.

In the above-described embodiment, an example in which the operation mode setting device 4 is configured together with the virtualization infrastructure 3 in the market as a controller of the system 1 has been described, but the present embodiment is not limited to this aspect.

As illustrated in FIG. 9, in Modification 1, the operation mode setting device 4 is provided in each of pieces of the hardware 5a, 5b, 5c, 5d, . . . constituting the system 1.

The operation mode setting device 4 in Modification 1 has the same configuration as the operation mode setting device 4 of the above-described embodiment, and performs substantially the same processing, and thus detailed description thereof is omitted.

In Modification 1, the monitoring unit 42 of the operation mode setting device 4 collects the metrics data of the hardware 5 in which each operation mode setting device 4 is provided.

The HW setting control unit 43 sets the operation mode of the hardware 5 in which the operation mode setting device 4 is provided. That is, in Modification 1, the operation mode setting device 4 provided in each piece of hardware 5 individually sets the operation mode of the hardware 5.

As in the above-described embodiment, when there is an increase or decrease in the load factor LF that cannot be sufficiently handled by changing the operation mode, the HW setting control unit 43 instructs the virtualization infrastructure 3 to perform scaling. In the virtualization infrastructure 3, scaling instructions input from the operation mode setting device 4 of each piece of hardware 5 are aggregated. The virtualization infrastructure 3 can increase or decrease the number of virtual machines 6/containers and increase or decrease the number of pieces of the hardware 5 on the basis of the information on the aggregated scaling instructions.

As described above, the operation mode setting device 4 according to Modification 1 is provided as the controller 2 in the hardware 5 constituting the system 1.

The aspect of Modification 1 is particularly effective in a virtualization environment in which pieces of hardware 5 having different specifications are mixed. That is, it is possible to create a different operation mode(s) for each piece of hardware 5 according to the specifications of each piece of hardware 5 and individually set an operation mode by the operation mode setting device 4 provided on a per-hardware 5 basis.

In addition, in Modification 1, as each piece of hardware 5 can quickly perform an operation mode setting after collecting the metrics data, it is possible to perform control in a short span according to a change in the load factor LF of the hardware 5.

Note that the present invention is not limited to the above-described embodiments and that many modifications can be made by those skilled in the art within the technical idea of the present invention.

### REFERENCE SIGNS LIST

1 System

2 Controller

3 Virtualization infrastructure

4 Operation mode setting device

5 Hardware

6 Virtual machine

7 Load balancer

31 Resource management unit

32 Virtual machine control unit

33 Hardware start/stop control unit

34 Storage unit

41 Power characteristic data calculation unit

42 Monitoring unit

43 Hardware setting control unit (operation mode setting unit)

44 Storage unit

441 Operation mode list

442 Power characteristic data

1. An operation mode setting device to be provided in a system including hardware and a virtualization infrastructure that constructs virtual machines or containers by allocating resources of the hardware, the operation mode setting device comprising:
a storage unit configured to store
a plurality of operation modes each including a combination of items which relate to power consumption of the hardware and which can be dynamically set in the hardware, and,
for each of the plurality of operation modes, power characteristic data including power efficiency and a performance index value, acquired while varying a load factor of the hardware;
a monitoring unit configured to monitor the hardware in operation to acquire metrics data including a current load factor of the hardware; and
an operation mode setting unit configured to consult the power characteristic data to select an operation mode from the plurality of operation modes in descending order of the power efficiency at the current load factor in the metrics data and, if the performance index value at the current load factor in the selected operation mode satisfies a predetermined performance requirement of the hardware, cause the hardware to operate in the selected operation mode.

2. The operation mode setting device according to claim 1,
wherein, the operation mode setting unit is further configured to, at start of an operation of the hardware, consult the power characteristic data to select an initial operation mode in which the power efficiency at a load factor equal to or less than a predetermined value is highest in the plurality of operation modes and cause the hardware to operate in the selected initial operation mode.

3. The operation mode setting device according to claim 1,
wherein the operation mode setting unit is further configured to, if a load factor acquired in the selected operation mode is lower than a predetermined threshold, instruct the virtualization infrastructure to execute scaling of the virtual machines or the containers.

4. The operation mode setting device according to claim 1, further comprising:
a power characteristic data calculation unit configured to, for each of the plurality of operation modes, calculate the power characteristic data including the power efficiency and the performance index value of the hardware while varying the load factor of the hardware.

5. An operation mode setting method of an operation mode setting device to be provided in a system including hardware and a virtualization infrastructure that constructs virtual machines or containers by allocating resources of the hardware, the operation mode setting device including a storage unit configured to store a plurality of operation modes each including a combination of items which relate to power consumption of the hardware and which can be dynamically set in the hardware, and, for each of the plurality of operation modes, power characteristic data including power efficiency and a performance index value, acquired while varying a load factor of the hardware, the operation mode setting method comprising steps of, by the operation mode setting device:
monitoring the hardware in operation to acquire metrics data including a current load factor of the hardware, and
consulting the power characteristic data to select an operation mode from the plurality of operation modes in descending order of the power efficiency at the current load factor in the metrics data and, if the performance index value at the current load factor in the selected operation mode satisfies a predetermined performance requirement of the hardware, causing the hardware to operate in the selected operation mode.

6. A non-transitory computer-readable medium storing a computer program for causing a computer to function as the operation mode setting device according to claim 1.

7. A system comprising:
hardware;
a virtualization infrastructure that constructs virtual machines or containers by allocating resources of the hardware; and
an operation mode setting device provided together with the virtualization infrastructure as a controller of the hardware,
wherein the operation mode setting device comprises:
a storage unit configured to store
a plurality of operation modes each including a combination of items which relate to power consumption of the hardware and which can be dynamically set in the hardware, and,
for each of the plurality of operation modes, power characteristic data including power efficiency and a performance index value, acquired while varying a load factor of the hardware;
a monitoring unit configured to monitor the hardware in operation to acquire metrics data including a current load factor of the hardware; and
an operation mode setting unit configured to consult the power characteristic data to select an operation mode from the plurality of operation modes in descending order of the power efficiency at the current load factor in the metrics data and, if the performance index value at the current load factor in the selected operation mode satisfies a predetermined performance requirement of the hardware, cause the hardware to operate in the selected operation mode.

8. A system comprising:
hardware; and
a virtualization infrastructure that constructs virtual machines or containers by allocating resources of the hardware,
wherein the hardware includes an operation mode setting device provided as a controller, and
wherein the operation mode setting device comprises:
a storage unit configured to store
a plurality of operation modes each including a combination of items which relate to power consumption of the hardware and which can be dynamically set in the hardware, and,
for each of the plurality of operation modes, power characteristic data including power efficiency and a performance index value, acquired while varying a load factor of the hardware;
a monitoring unit configured to monitor the hardware in operation to acquire metrics data including a current load factor of the hardware; and
an operation mode setting unit configured to consult the power characteristic data to select an operation mode from the plurality of operation modes in descending order of the power efficiency at the current load factor in the metrics data and, if the performance index value at the current load factor in the selected operation mode satisfies a predetermined performance requirement of the hardware, cause the hardware to operate in the selected operation mode.
